(19) United States
(12) Patent Application Publication
(10) Pub. No.: US 2017/0350184 A1
(43) Pub. Date: Dec. 7, 2017

(54) DOOR WRAP

(71) Applicant: Richard Shock, Denver, CO (US)

(72) Inventor: Richard Shock, Denver, CO (US)

(21) Appl. No.: 15/175,212

(22) Filed: Jun. 7, 2016

(51) Int. Cl. E06B 3/30; B44C 1/10

(52) U.S. Cl. CPC E06B 3/30; B44C 1/10

(57) ABSTRACT

A door wrap has an inner and outer face. The outer face displays a main decoration and can have a main message zone. Additional components can include: a plurality of cut-outs, a plurality of attachable art pieces, and a door attachment means. The inner face faces towards an outer surface of a door and so is itself generally not visible when mounted. The inner face of the door wrap can also include second main decorations, main message zones, and attachable art pieces. The door attachment means can be a grommet attachment in each of the four corners and each including an elastic cord that can be wrapped over the corner of the door to secure the door wrap. Cut-outs can be scored so that a user can easily remove that portion of the door wrap to allow a door handle, etc. to protrude therethrough.

### TECHNICAL FIELD

The present invention relates generally to the fields of celebrations, announcements, gifts and decorations; and more particularly, to a door wrap that is attached to a front or rear face of a door and displays a decorative communication such as “Happy Birthday”, “Happy Holidays”, “Secretary Week”, photo/drawing/artwork, etc.

### BACKGROUND

Human beings have been decorating our homes since we lived in rock caves and hide tents. As shelters transitioned from communal to individual or family-unit based, further decoration and personalization became possible. Most such decorations and personalizations were then created and utilized by individuals, as the vast commercial markets of today and the excess resources necessary to acquire such items through commerce did not then generally exist. In more recent times, with the commercialization of cultural holidays and home decor, ornaments, streamers, decorations, artwork, ribbons, and other associated ornamentation have grown in commercial availability and variety.

However, because today's mass-commerce is based on producing and selling large numbers of copies of each item, the personalization and uniqueness of home decorations and ornamentation has dwindled. Furthermore, although temporary decorations are common, most are not sturdy enough to withstand long-term use and so are usually installed and removed in rapid succession, with many then disposed of or otherwise never to be used again. What is needed are personalized, customizable, sturdy decorations that are easily installed and removed, function as a gift as well as a decoration, and bring a message to the focal point of a home or room: the doorway.

### SUMMARY

One embodiment of the present invention can comprise a celebration/decoration door wrap. The door wrap can be constructed from a relatively thin (for example, one-sixteenth inch, more or less) white polyethylene vinyl, poster printing paper, printable surface material, or other similarly sturdy material(s). The door wrap should be generally slightly smaller in width and height than the door to which it is to be attached. For example, many doors are thirty six inches wide and eighty inches tall, and so door wraps for such doors should be thirty to thirty-five inches wide and seventy-four to seventy-nine inches tall. In another embodiment, a door wrap should be the same height as the door, and can be either the same width or slightly more narrow. In yet other embodiments, door wraps can be wider or narrower, and/or shorter or taller than the door to which they are to be attached. The door wraps are basically two-dimensional with an inner face and an outer face (the distance between the faces being only approximately one-sixteenth of an inch). The inner face presses against the door and so is itself not visible unless the door is transparent (i.e., a glass door). Thus, in many cases, only the outer face of the door wrap will have ornamentation. However, it is contemplated that both the inner face and the outer face of a door wrap made for a glass door would have ornamentation; additionally, both faces could be ornamented so that the door wrap could be simply flipped over to display/decorate for a second event, occasion, etc.

Door wraps can have a door attachment means such as stainless steel grommet attachments in each of the four corners and each including an elastic cord therethrough which can be wrapped over the corner of the door to secure the door wrap thereto. Other attachment means are contemplated. In high-wind, or other such environments, door wraps can utilize other door attachment means such as wrap-hooks secured with elastic lines.

Door wraps may be made from materials on which erasable markers (or similar) can be applied and easily removed. This allows door wraps to be easily customized. For example, a Happy Birthday door wrap could have various locations in which a user would write in the name of the person having the birthday, a personal message, artwork, etc. Door wraps may also be customizable by the addition of secondary decorations. For example, additional art work elements and/or packages of art work can be purchased separately. These pieces can adhere to the door wrap and be peeled off and re-positioned as desired (or add-on adhesive materials can be employed). For example, a standard door wrap could have pieces such as a football, a cake, words, flowers, etc. added onto the door wrap by a user to further customize and personalize a given door wrap.

Door wraps can be made in various grades, for example: an interior door grade, an exterior door grade, commercial grade, etc. Said grades imply progressively more resilient and/or weather-resistant versions of the door wraps. Additional high-wind door wraps can have wind-resistant features such as wind flow-through cut-outs or screening, high-force door attachment means, etc.

A door wrap user can cut out and remove portions of the door wrap to accommodate handles, locks, door knockers, peepholes, etc. Additionally, such cut-outs can be pre-scored so that a user need only remove the ones appropriate for his or her own door.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a front perspective view of an exemplary embodiment of a door wrap on an exterior door;

FIG. 2 illustrates a rear elevation view of an exemplary embodiment of a door wrap;

FIG. 3 illustrates front perspective view of an exemplary embodiment of a door wrap on an interior door; and

FIG. 4 illustrates a front elevation view of another exemplary embodiment of a door wrap.

### DETAILED DESCRIPTION

In the following discussion, numerous specific details are set forth to provide a thorough understanding of the present disclosure. However, those skilled in the art will appreciate that embodiments may be practiced without such specific details. Furthermore, lists and/or examples may be provided and should be interpreted as exemplary only and in no way limiting embodiments to only those lists/examples.

Exemplary embodiments are described below in the accompanying Figures. The following detailed description provides a review of the drawing Figures in order to provide an understanding of, and an enabling description for, these embodiments. One having ordinary skill in the art will understand that in some cases well-known structures and functions have not been shown or described in detail to avoid unnecessarily obscuring the description of the embodiments.

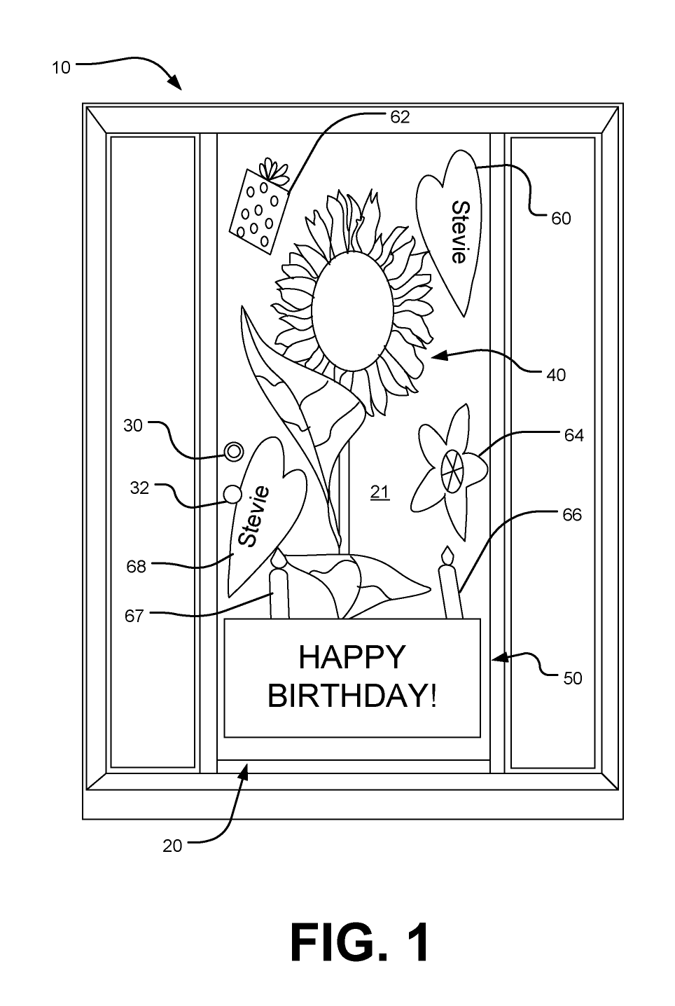

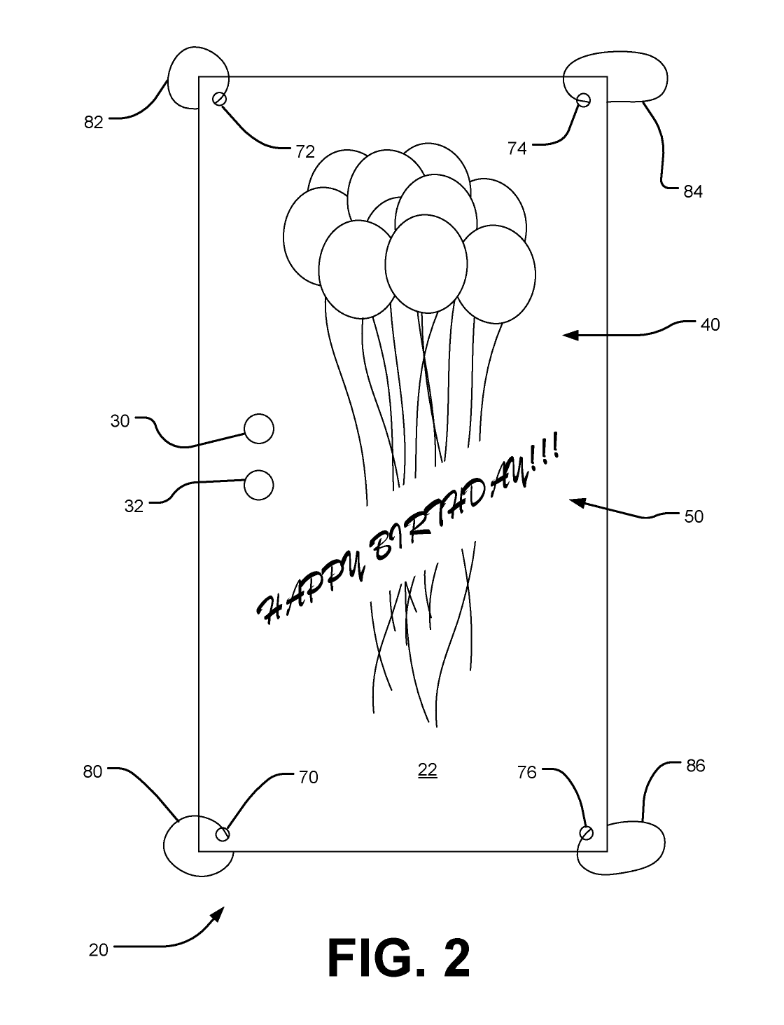

Referring now to the drawings, FIG. 1 illustrates a front perspective view of an exemplary embodiment of a door wrap 20 on an exterior door 10. The exterior door 10 has two side panel accents and is usually surrounded by a wall (not shown). The door itself is mostly hidden behind the door wrap 20. This exemplary door wrap is designed to help celebrate a birthday for someone named “Stevie”. Notice that the main decoration 40 of the door wrap comprises artwork depicting a sunflower in the embodiment illustrated in FIG. 1. Other main decorations 40 can include a background that extends over the door wrap outer face 21. In other embodiments, the main decorations 40 can be smaller and/or cover less of the outer face 21. Additionally, two-sided door wraps can include main decorations 40 on both the inner face 22 (see FIG. 2) and the outer face 21 (the inner face being shaped/sized similar to the outer face and comprises that portion of the door wrap facing the surface of the door 10). Regardless of the particular embodiment of the main decorations 40, they comprise the primary decor/theme of a given door wrap 20.

The door wrap illustrated in the embodiment in FIG. 1 includes two cut-outs: a lower door handle cut-out 32 and an upper door lock cut-out 30. In other embodiments, said cut-outs 30 and 32 may be larger, smaller, different shapes, and/not not used depending on the type of door/handle(s)/lock(s) on the underlying door 10. For example, a door might use a rectangular keypad lock and so the upper door lock cut-out 30 may need to be rectangular to accommodate a rectangular keypad lock.

In addition to the main decorations 40, the door wrap depicted in FIG. 1 also comprises a main message zone 50 and a plurality of attachable art pieces 60, 62, 64, 66, 67, and 68. The main message zone 50 comprises an area on the door wrap which conveys the main message for a particular door wrap. Usually, this main message is directly related to a holiday, event, occasion, etc. In some embodiments, no main message zone 50 is employed. In FIG. 1, the main message is “Happy Birthday” and is included in a pre-existing condition on the main message zone 50. In alternate embodiments, the main message zone 50 can comprise a material that accepts erasable markers (or similar) and the user can write in the main message zone 50 the main message (which can also be artwork, or other non-word based message, or a combination of words, symbols, art, etc.).

The first attachable art piece 60 is a heart-shaped device with the birthday person's name added thereto. Such art pieces can be available already personalized with a name, or can be made from a material that accepts erasable markers (or similar) The second attachable art piece 62 is a simplified present. Similarly, the third attachable art piece 64 comprises a simplified flower. Art pieces 66 and 67 comprise a pair of festive candles, while the final depicted art piece 68 is another embodiment of a heart with the birthday person's name scrolled thereon.

The door attachment means for the door wrap is not illustrated in FIG. 1, see FIG. 2 for an exemplary embodiment thereof In the embodiment in FIG. 1, alternate, non-visible attachment means such as an adhesive may be employed between the door's outer surface and the inner face of the door wrap to secure the door wrap on the door. Also, it is important to note that if the door wrap is sized to approximately match the dimensions of the door, when an exterior door is closed, the door wrap is pressed between the door itself and the frame and/or weather-stripping. This sandwiching effect helps to ensure that the door wrap is retained on the door, even in windy conditions.

FIG. 2 illustrates a rear elevation view of an exemplary embodiment of a door wrap 20. Here, in order to not unduly clutter the drawing figure and instead focus on other features, the main decorations 40, main message zone 50, and attachable art pieces are minimized or not present. The embodiment in FIG. 2 does depict both an upper door lock cut-out 30 and lower door handle cut-out 32. As mentioned above, these cut-outs 30 and 32 can be larger, smaller, differently shaped, and present or not present as determined by the needs of the underlying door. Additional cut-outs can also be present for items such as viewing windows, peepholes, door knockers, etc. In alternate embodiments, cut-outs can be present on either/both the left and rights sides to accommodate left or right handled doors without requiring the door wrap to be installed with the inner surface 22 facing out.

Highlighted in FIG. 2 is one exemplary embodiment of a door attachment means comprising four grommet attachments 70, 72, 74, and 76 and four elastic retention cords 80, 82, 84 and 86. In one embodiment, four stainless steel grommets are utilized, one in each corner. They may comprise a size 00 long/plain washer with an inner diameter hole of 0.188 inches and a length under the flange of 0.25 inches, as examples. In other embodiments, other sizes, shapes, styles, and/or types of washers/grommet attachments may be used. Similarly, the elastic retention cords 80, 82, 84 and 86 depicted in FIG. 2 can be “PP” or origin latex elastic thread core with a high tenacity polyester outer layer, a diameter of 2.5 to 16 mm, and circumference of eight to twelve inches. In other embodiments, other types/styles/kinds/sizes of elastic retention cords are contemplated. In yet other embodiments, retention cords 80, 82, 84, and 86 can be thin and/or flattened to allow the door to close more easily upon them. Furthermore, said cords and/or grommet attachments may be colored and/or textured in various ways as desired.

When attaching the door wrap to the door, a user simply places the door wrap's inner face against the surface of the door with the door in an open position. Then, each elastic retention cord 80, 82, 84, and 86 is then wrapped around its corresponding corner of the door 10. In other embodiments, alternative door attachment means are contemplated such as adhesives, glue, staples, nails, magnets, door hooks, etc.

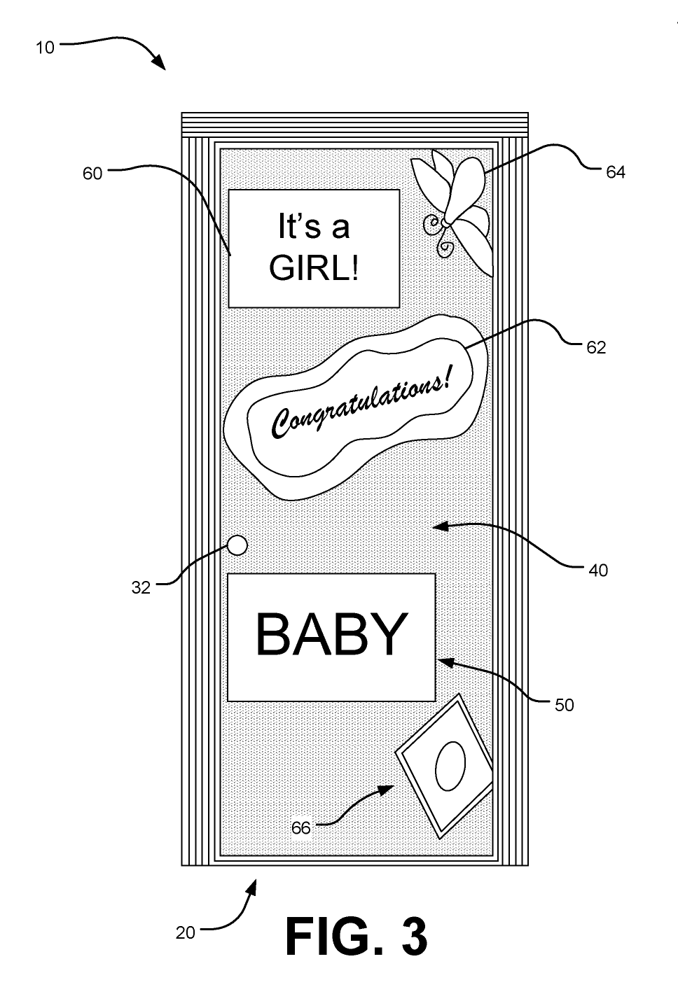

FIG. 3 illustrates front perspective view of an exemplary embodiment of a door wrap 20 on an interior door 10. Note how this embodiment is similar to that shown in FIG. 1, and yet celebrates a completely different event/occasion and has a different look. Since interior doors 10 often do not utilize a secondary dead-bolt locking system, only the lower door handle cut-out 32 is necessary here. The main decorations 40 are polka-dots that are spread over much of the outer face of the door wrap 10, and a main message zone 50 and attachable art pieces 60, 62, 64 and 66 are also present. In another embodiment, the attachable art pieces 60, 62, 64 and 66 are not utilized.

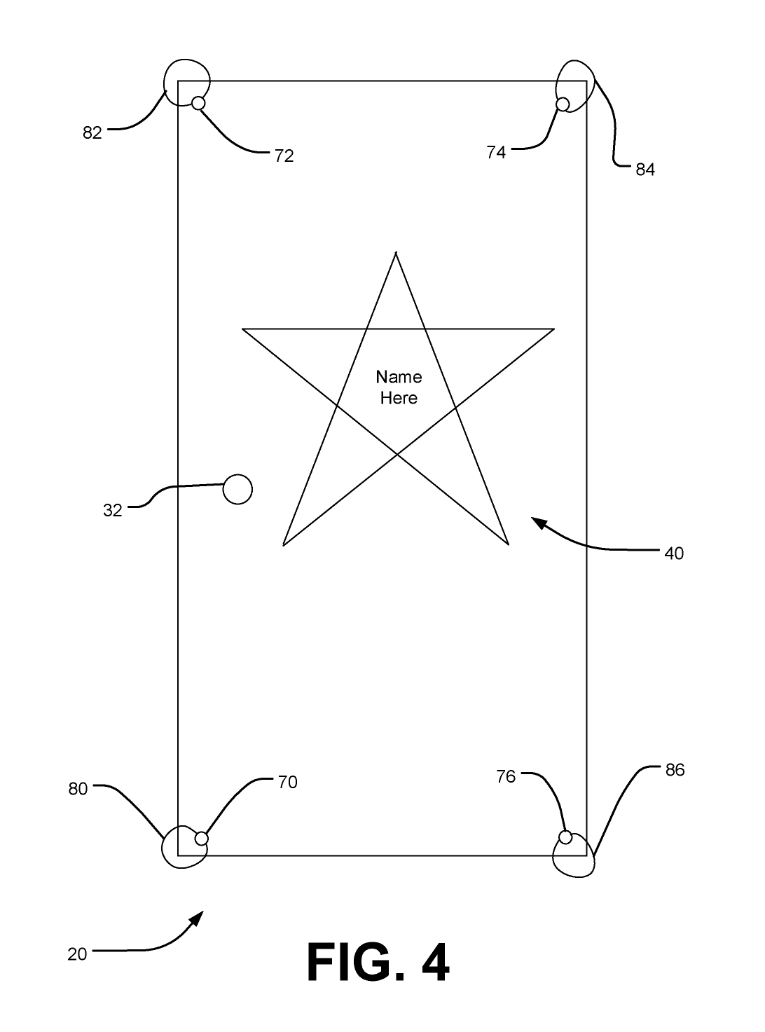

FIG. 4 illustrates a front elevation view of another exemplary embodiment of a door wrap 20. As in FIG. 3, the door wrap 20 illustrated here has a main decoration 40. Here the main decoration 40 comprises a star as on a movie star's dressing room door with the person's name in the Name Here location. Since this particular door wrap is more focused on providing a decorative function rather than a celebratory function, neither a main message zone nor any attachable art pieces are utilized. However, in other embodiments, such components may also exist (for example: an attachable art piece could comprise interchangeable labels for whichever star is utilizing the room at a given time; an erasable marker note board could be attached; etc.). Additionally, the main decoration 40 can be a photograph or other artwork that covers most of the door wrap 20.

Note also the deployment of the door attachment means depicted in FIG. 2. The four grommet attachments 70, 72, 74, and 76 and four elastic retention cords 80, 82, 84 and 86 are shown in FIG. 4. Here, the grommet attachments 70, 72, 74 and 76 further comprise tie-downs which lock into the grommets/holes in the door wrap and provide ports through which the elastic retention cords 80, 82, 84 and 86 extend. The grommet attachments can be spaced further from or closer to the corners of the door wrap; in other embodiments, the positions of the grommet attachments 70, 72, 74, and 76 can vary and can be customized based on the strength of the material from which the door wrap is constructed, the size and strength of the grommet attachments used, etc. In other embodiments, fewer or more than four grommet attachments/elastic retention cord combinations may be employed.

Since the embodiment illustrated in FIG. 4 is designed for an interior door, it may not utilize an upper lock 30 as illustrated in FIGS. 1 and 2. Instead, only a door handle cutout 32 is shown. Additional cutouts can be utilized to accommodate other needs. For example, if a brass name-plate or a decoration is already in place on the door, the door wrap 20 can either have a pre-made cutout ready to be removed to expose the name-plate/decoration, or the user can simply cut away the covering portion of the door wrap as needed.

In one embodiment, a door wrap can comprise an outer face 21 and an inner face 22 with a thickness therebetween, the outer face being a first side of the door wrap and the inner face being a second side of the door wrap. Additionally, a door wrap can comprise a first main decoration displayed on the outer face, the first main decoration comprising a first primary decor of the door wrap, and a door attachment means that removably attaches the door wrap to a door. In one embodiment, the door attachment means comprises a plurality of grommet attachments attached to the door wrap and a plurality of retention cords attached to the grommet attachments and sized to fit over door corners.

The plurality of grommet attachments can include at least four grommet attachments, one for each corner of a rectangular shaped door wrap and door and the plurality of retention cords can include at least four retention cords, one for each grommet attachment.

The door wrap can further comprise a first main message zone attached to the outer face and containing a first message. Alternatively, or in addition to, the first main message zone, a plurality of attachable art pieces can be attached to the outer face to enhance a decorative appearance of the door wrap.

In another embodiment, a door wrap can comprise: an outer face and an inner face with a thickness therebetween, the outer face being a first side of the door wrap and the inner face being a second side of the door wrap; a first main decoration displayed on the outer face, the first main decoration comprising a first primary decor of the door wrap; and a second main decoration displayed on the inner face, the second main decoration comprising a second primary decor of the door wrap. In addition, a first cut-out can be included, comprising a pre-scored portion of the door wrap that allows a user to easily remove that portion so that at least one of a door handle, a door lock, and a door decoration is accessible through the door wrap. In either case, the door wrap should also comprise a door attachment means that removably attaches the door wrap to a door.

The door attachment means in any embodiment can comprise a plurality of grommet attachments attached to the door wrap and a plurality of retention cords attached to the grommet attachments and sized to fit over door corners. Similarly, the door wrap in this embodiment can comprise a first main message zone attached to the outer face and containing a first message; it may also have a second main message zone attached to the inner face and containing a second message.

Regardless of whether or not a particular embodiment includes message zones, the embodiment can further comprise a first plurality of attachable art pieces attached to the outer face and enhancing a first decorative appearance of the door wrap. In addition, a second plurality of attachable art pieces can be attached to the inner face and can enhance a second decorative appearance of the door wrap.

While particular embodiments have been described and disclosed in the present application, it is clear that any number of permutations, modifications, or embodiments may be made without departing from the spirit and the scope of this disclosure.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize. Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers are incorporated herein by reference. Aspects of embodiments can be modified, if necessary, to employ the systems, functions, and concepts of the various references to provide yet further embodiments.

In light of the above “Detailed Description,” the Inventor may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the inventor. As discussed herein, specific terminology used when describing certain features or aspects should not be taken to imply that the terminology is being redefined herein to be restricted to any specific characteristics, features, or aspects of the embodiments with which that terminology is associated.

While certain aspects are presented below in certain claim forms, the inventor contemplates the various aspects in any number of claim forms. Accordingly, the inventor reserves the right to add additional claims after filing the application to pursue such additional claim forms for other aspects.

The above specification, examples and data provide a description of the structure and use of exemplary implementations of the described systems, articles of manufacture and methods. It is important to note that many implementations can be made without departing from the spirit and scope of the disclosure.

What is claimed is:

1. A door wrap, comprising:
an outer face and an inner face with a thickness therebetween, the outer face being a first side of the door wrap and the inner face being a second side of the door wrap;
a first main decoration displayed on the outer face, the first main decoration comprising a first primary decor of the door wrap;
a first cut-out comprising a pre-scored portion of the door wrap that allows a user to easily remove that portion so that at least one of a door handle, a door lock, and a door decoration to be accessible through the door wrap; and
a door attachment means that removably attaches the door wrap to a door.

2. The door wrap of claim 1, wherein the door attachment means comprises a plurality of grommet attachments attached to the door wrap and a plurality of retention cords attached to the grommet attachments and sized to fit over door corners.

3. The door wrap of claim 2, wherein the plurality of grommet attachments include at least four grommet attachments, one for each corner of a rectangular shaped door wrap and door and wherein the plurality of retention cords include at least four retention cords, one for each grommet attachment.

4. The door wrap of claim 1, further comprising:
a first main message zone attached to the outer face and containing a first message.

5. The door wrap of claim 1, further comprising:
a plurality of attachable art pieces attached to the outer face and enhancing a decorative appearance of the door wrap.

6. The door wrap of claim 2, further comprising:
a first main message zone attached to the outer face and containing a first message.

7. The door wrap of claim 2, further comprising:
a plurality of attachable art pieces attached to the outer face and enhancing a decorative appearance of the door wrap.

8. The door wrap of claim 3, further comprising:
a first main message zone attached to the outer face and containing a first message.

9. The door wrap of claim 8, further comprising:
a plurality of attachable art pieces attached to the outer face and enhancing a decorative appearance of the door wrap.

10. A door wrap, comprising:
an outer face and an inner face with a thickness therebetween, the outer face being a first side of the door wrap and the inner face being a second side of the door wrap;
a first main decoration displayed on the outer face, the first main decoration comprising a first primary decor of the door wrap; and
a door attachment means that removably attaches the door wrap to a door, wherein the door attachment means comprises a plurality of grommet attachments attached to the door wrap and a plurality of retention cords attached to the grommet attachments and sized to fit over door corners.

11. The door wrap of claim 10, wherein the plurality of grommet attachments include at least four grommet attachments, one for each corner of a rectangular shaped door wrap and door and wherein the plurality of retention cords include at least four retention cords, one for each grommet attachment.

12. The door wrap of claim 10, further comprising:
a first main message zone attached to the outer face and containing a first message.

13. The door wrap of claim 12, further comprising:
a plurality of attachable art pieces attached to the outer face and enhancing a decorative appearance of the door wrap.

14. A door wrap, comprising:
an outer face and an inner face with a thickness therebetween, the outer face being a first side of the door wrap and the inner face being a second side of the door wrap;
a first main decoration displayed on the outer face, the first main decoration comprising a first primary decor of the door wrap;
a second main decoration displayed on the inner face, the second main decoration comprising a second primary decor of the door wrap;
a first cut-out comprising a pre-scored portion of the door wrap that allows a user to easily remove that portion so that at least one of a door handle, a door lock, and a door decoration to be accessible through the door wrap; and
a door attachment means that removably attaches the door wrap to a door.

15. The door wrap of claim 14, wherein the door attachment means comprises a plurality of grommet attachments attached to the door wrap and a plurality of retention cords attached to the grommet attachments and sized to fit over door corners.

16. The door wrap of claim 14, further comprising:
a first main message zone attached to the outer face and containing a first message.

17. The door wrap of claim 16, further comprising:
a second main message zone attached to the inner face and containing a second message.

18. The door wrap of claim 14, further comprising:
a first plurality of attachable art pieces attached to the outer face and enhancing a first decorative appearance of the door wrap.

19. The door wrap of claim 18, further comprising:
a second plurality of attachable art pieces attached to the inner face and enhancing a second decorative appearance of the door wrap.

20. The door wrap of claim 17, further comprising:
a first plurality of attachable art pieces attached to the outer face and enhancing a first decorative appearance of the door wrap; and
a second plurality of attachable art pieces attached to the inner face and enhancing a second decorative appearance of the door wrap.
